(19) United States
(12) Patent Application Publication
(10) Pub. No.: US 2012/0240787 A1
(43) Pub. Date: Sep. 27, 2012

(54) SAFETY DEVICE FOR AN ELECTRICAL STOVE

(76) Inventor: Tony Boulanger, Mirabel (CA)

(21) Appl. No.: 13/427,487

(22) Filed: Mar. 22, 2012

Related U.S. Application Data
(60) Provisional application No. 61/457,411, filed on Mar. 22, 2011.

(51) Int. Cl. H05B 1/02; A47J 27/62

(52) U.S. Cl. 99/332; 219/414

(57) ABSTRACT

A safety device for an electrical stove comprising a main control button and a timer relay interposed between the control button and the stove.

### CROSS-REFERENCE TO RELATED APPLICATIONS

This application claims priority of U.S. Provisional Application for Patent No. 61/457,411 filed Mar. 22, 2011, the content of which is incorporated herein in its entirety by reference.

### FIELD OF THE INVENTION

The present invention relates to safety devices for an electrical stove, and is more particularly concerned with a device which offers a timed automatic interruption of electrical power in the event that the stove has been left on unintentionally or inadvertently.

### BACKGROUND OF THE INVENTION

It is well known in the art to provide security devices for use in combination with electrical stoves to cut off power to an electrical stove in the event of unauthorized usage. In such cases, authorization to use the stove is generally provided by the employment of coded entry to the power circuit, requiring a degree of computerized programming and thus for some users presenting an unwelcome complication in operating the stove. In this latter respect, people of advanced age and suffering from short term memory loss, occasioned for example by the onset of senility can often forget that a stove has been activated and accordingly the continued supply of power gives rise to the possibility or accidents resulting in injury or in extremis the loss of life.

One example of such a security device is disclosed in U.S. Pat. No. 5,734,206 to Keizer et al who propose the use of a keypad offering the means of providing coded messages to the stove allowing or preventing power supply thereto. Various functions can be monitored by the device dependent upon the inputted code. As intimated supra such a device would be inappropriate for people challenged in the manner described since the device requires the memorization of the relevant code to effect authorization or the cancellation thereof.

Another example of a security device intended to be used for the same purpose is described in U.S. Pat. No. 6,130,413 to Rak who advocates a system employing a means of detecting the presence of a person operating the stove. In the event that the presence of a person is no longer detected, the device in question automatically interrupts electrical power to some, but not all, of the functions of the stove.

There is accordingly a need to provide an improved and more positive solution for the problem of ensuring that an electrical stove does not remain powered should it be left unattended inadvertently or unintentionally for a certain period.

### SUMMARY OF THE INVENTION

It is therefore a general object of the present invention to provide an improved safety device for an electrical stove.

An advantage of the present invention is that the safety device for an electrical stove provides for the automatic disconnection of an electrical supply after a set period of time.

Another advantage of the present invention is that the safety device for electrical stove provides for such disconnection after a limited time period of varying length predetermined by the use.

A further advantage of the present invention is that the safety device for an electrical stove is optionally provided with an override should the setting of time period be inappropriate in a controlled set of circumstances.

Still another advantage of the present invention is that the safety device for an electrical stove provides for a fail-to-safety facility.

According to the invention a safety device for an electrical stove comprises a main control button adapted to the flow of power to the stove, a timer relay interposed between the control button and the stove and adapted in use to interrupt power flow after a predetermined period of operating time.

A control box may be provided in association with the timer relay providing a facility to vary the period of operating time.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, wherein:

FIG. 1 is a simplified front perspective view of a safety device for an electrical stove in accordance with an embodiment of the present invention; and

FIG. 2 is a scrap view of an alternative embodiment of the device depicted in FIG. 1.

### DETAILED DESCRIPTION OF THE INVENTION

With reference to the annexed drawings the preferred embodiments of the present invention will be herein described for indicative purpose and by no means as of limitation with like numerals of reference being employed for like parts in differing embodiments of the invention or its details.

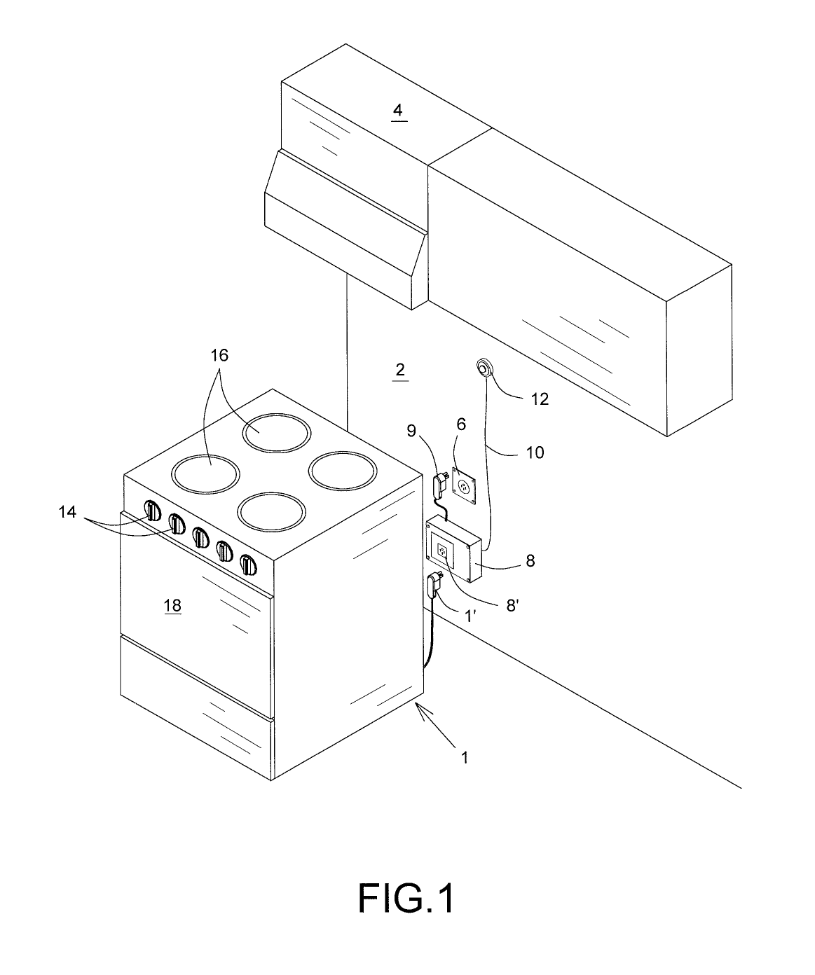

Referring first to FIG. 1 there is shown an electrical stove 1 temporarily moved away from a wall 2, which has mounted thereon a conventional extractor fan unit 4 at an elevated level.

Set in the wall 2 behind the stove 1 is an electrical power socket 6 for the supply of power (240 volts) to the stove. In close adjacency to the socket 6 there is mounted on the wall 2 a relay device 8 interposed between the power socket 6 and the stove 1 the power plug 1′ of which is insertable into a socket 8′ on the relay device 8. A power plug 9 of the device 8 is insertable into the socket 6.

A control cable 10 provided with an operating button 12 connects to the relay device 8 and is adapted to initiate the supply of power from the relay device 8 to the stove 1. The normal controls, viz. those illustrated by control knobs 14 are then employed as in usual practice to effect powering of the relevant conventional elements 16 and/or the oven 18.

Accordingly in use the person wishing to use the stove 1 is obliged to press the button 12 to secure the supply of electrical power via the relay device 8 to the stove. The relay device 8 incorporates a timer (not shown) of conventional type that allows the flow of electricity to the stove 1 for a predetermined time period, say 1 hour. If, following usage of the stove 1, the person should inadvertently leave the power ‘on’ to any one or more of the elements 16 or to the oven 18 following the expiration of the set time period, the relay device 8 will automatically interrupt the power supply to the stove 1 thus avoiding any overheating resulting from failure to turn off the power to the stove.

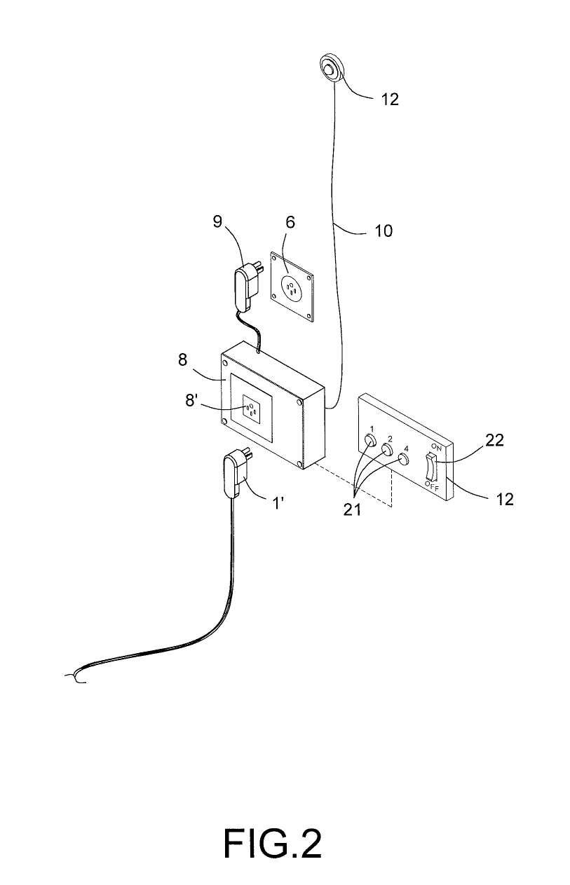

Referring now to FIG. 2, in addition to the relay device 8 and the control cable 10 with operating button 12, there is shown an alternate control in the form of a box 20 providing alternative timer settings selectable through buttons 1, 2 and 4, identified by reference 21, representing 1, 2 or 4 hours duration. In this manner, the time period of the relay device 8 may be varied dependent upon the expected duration of stove operation; the relay operates in the same way as previously described in relation to FIG. 1, namely by effecting an automatic interruption of power supply to the stove 1 following a failure to turn off the heating elements of the stove at the end of the selected time period.

The device represents a relatively simple solution to the problem of stoves being unintentionally left on through forgetfulness or neglect, whereby an automatic interruption of the power supply is effected to avoid the dangers inherent in the retention of fully powered heat by the stove.

It will be understood that a master override circuit breaker, represented as switch 22 on box 20, may be provided in order to allow a responsible person to utilize the stove in a normal mode, with the switch 22 in the OFF position for example, namely for longer periods of time than those dictated by the timer relay of the control box hereinbefore described.

Although the present invention of a safety device for an electrical stove has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A safety device for an electrical stove comprising a main control button adapted to the flow of power to the stove, a timer relay interposed between the control button and the stove and adapted in use to interrupt power flow after a predetermined period of operating time.

2. A safety device according to claim 1 and comprising a control box provided in association with the timer relay providing a facility to vary the period of operating time.
